(19) United States
(12) Patent Application Publication
(10) Pub. No.: US 2015/0086891 A1
(43) Pub. Date: Mar. 26, 2015

(54) APPARATUS AND METHOD FOR STARTING FUEL CELL VEHICLE IN EMERGENCY

(71) Applicant: Hyundai Motor Company, Seoul (KR)

(72) Inventors: Seon Hak KIM, Yongin-si (KR); Kyu-Il LEE, Yongin-si (KR); Kyung Won SUH, Seoul (KR); Sung Gone YOON, Suwon-si (KR)

(73) Assignee: Hyundai Motor Company, Seoul (KR)

(21) Appl. No.: 14/106,272

(22) Filed: Dec. 13, 2013

(30) Foreign Application Priority Data
Sep. 25, 2013 (KR) 10-2013-0113649

(51) Int. Cl. H01M 8/04

(52) U.S. Cl. CPC H01M 8/04298
USPC 429/429

(57) ABSTRACT

An apparatus and a method for starting a fuel cell vehicle in an emergency by using the blower of an air conditioning system of the vehicle are disclosed. Thus, upon failure of a high voltage system including a high voltage DC-DC converter or a high voltage battery used as a power source of an air blower during start-up of a fuel cell, air is supplied to the fuel cell so as to be started in the emergency, thereby ensuring starting efficiency of the vehicle and security to the driver in the emergency.

### CROSS-REFERENCE TO RELATED APPLICATION

This application claims under 35 U.S.C. §119(a) the benefit of Korean Patent Application No. 10-2013-0113649, filed on Sep. 25, 2013, the entire contents of which are incorporated herein by reference.

### BACKGROUND

(a) Technical Field

The present invention relates to an apparatus and a method for starting a fuel cell vehicle in an emergency, and more particularly, to an apparatus and a method for starting a fuel cell vehicle in an emergency, by using a blower of an air conditioning system for the vehicle.

(b) Background Art

In general, a fuel cell system includes a fuel cell stack that generates electrical energy, a fuel supply system that supplies fuel (hydrogen gas) to the fuel cell stack, an air supply system that supplies air including oxygen, which is an oxidizing agent necessary for an electrochemical reaction, to the fuel cell stack, and a heat/water managing system that controls an operation temperature of the fuel cell stack.

When the hydrogen gas is supplied to a fuel electrode of the fuel cell stack, and the air is supplied to an air electrode of the fuel cell stack, the supplied hydrogen gas is separated into hydrogen ions and electrons by a catalyst oxidation reaction in the fuel electrode. At this time, the generated hydrogen ions are supplied to the air electrode through a poly-electrolyte film within the stack, and the electrons are supplied to the air electrode through an external circuit. In the air electrode, electricity is generated through a principle in which oxygen ions are generated by a catalyst reduction reaction between the supplied oxygen and the electrons, and water is generated by a combination of the hydrogen ions and the oxygen.

The electricity generated in the fuel cell is supplied to charge a high voltage battery to be used as electrical power for start-up of a fuel cell vehicle or electrical power of a motor for driving. However, in a case of an error or fault of a converter (Bi-Directional High voltage DC-DC Converter, BHDC) connected between the high voltage battery and the fuel cell, the vehicle enters a shutdown (S/D) sequence and is impossible to drive.

Further, in a case of a system that drives an air blower, by using the high voltage of a high voltage system including a high voltage converter or a high voltage battery, to start a fuel cell, the air blower is stopped when the high voltage system is abnormal, and air is no longer supplied to the air electrode of the fuel cell, so that start-up of the fuel cell becomes impossible.

In an attempt to solve the above-described problems, Korean Patent Publication No. 2012-20686 (published on Mar. 8, 2012) discloses a system and a method for starting a fuel cell vehicle in an emergency, in which an air blower is driven by a low voltage battery upon an error or fault of a high voltage system in a fuel cell system so that the fuel cell is started in the emergency. However, other emergency start-up methods in addition to the related art are required.

### SUMMARY OF THE DISCLOSURE

The present invention provides an apparatus and a method for starting a fuel cell vehicle in an emergency, in which, even in the case of a failure of a high voltage system including a high voltage DC-DC converter or a high voltage battery used as a power source of an air blower during start-up of a fuel cell, air is supplied to a fuel cell so that the fuel cell can be started in the emergency, thereby ensuring starting efficiency of a vehicle and stability of a driver in the emergency.

In accordance with an aspect of the present invention, there is provided an apparatus for starting a fuel cell in an emergency, including: a high voltage system connected with the fuel cell through a high voltage bus; an air blower operated by an electrical power supplied from the high voltage system to supply air to an air electrode of the fuel cell; an air supply pipe for emergency start-up connected between an air electrode inlet pipe of the fuel cell and an outlet pipe of an air conditioning blower connected to the inside of a vehicle; a three-way valve installed at a point where the outlet pipe and the air supply pipe for emergency start-up intersect each other, and guides air from the air conditioning blower to the inside of the vehicle or an air electrode inlet of the fuel cell; and a controller that controls change of an air flow path of the three-way valve such that air flows toward the air electrode inlet of the fuel cell, and controls the air conditioning blower to be turned on, in a case of an error or fault of the high voltage system.

In accordance with an aspect of the present invention, there is provided a method of starting a fuel cell in an emergency, including: operating a high voltage system connected with the fuel cell through a high voltage bus, with the fuel cell being started; determining abnormality of the high voltage system; operating an air conditioning blower when an air blower supplying air to an air electrode of the fuel cell, in a case of abnormality of the high voltage system, is not to be operated; guiding and supplying the air according to the operating of the air conditioning blower to the air electrode of the fuel cell; and starting the fuel cell in an emergency, by the air supplied from the air conditioning blower to the air electrode of the fuel cell.

The present invention provides the following effect through the above-described apparatus and method for solving the problems.

According to embodiments of the present invention, even in the case of a failure of the high voltage system including the high voltage DC-DC converter or the high voltage battery, air is readily supplied to the fuel cell by using the air conditioning blower so that the fuel cell can be started in the emergency.

In other words, through a configuration in which an air conditioning blower of an air conditioning system that is equipped in the fuel cell vehicle and is driven by a 12V battery, a pipe line that guides air from the air conditioning blower, and a three-way valve are simply added, the fuel cell can be started in an emergency in the case of the error or fault of the high voltage system, thereby improving starting efficiency and stability of the fuel cell.

### BRIEF DESCRIPTION OF THE DRAWINGS

The above and other features of the present invention will now be described in detail with reference to certain exemplary embodiments thereof illustrated the accompanying drawings which are given hereinafter by way of illustration only, and thus are not limitative of the present invention, and wherein:

FIG. 1 shows a configuration of an apparatus for starting a fuel cell vehicle in an emergency according to the present invention;

FIG. 2 is a flowchart showing a method of starting a fuel cell vehicle in an emergency according to the present invention; and

FIG. 3 shows an emergency start-up sequence of a fuel cell vehicle according to the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, an exemplary embodiment of the present invention will be described more specifically with reference to the accompanying drawings.

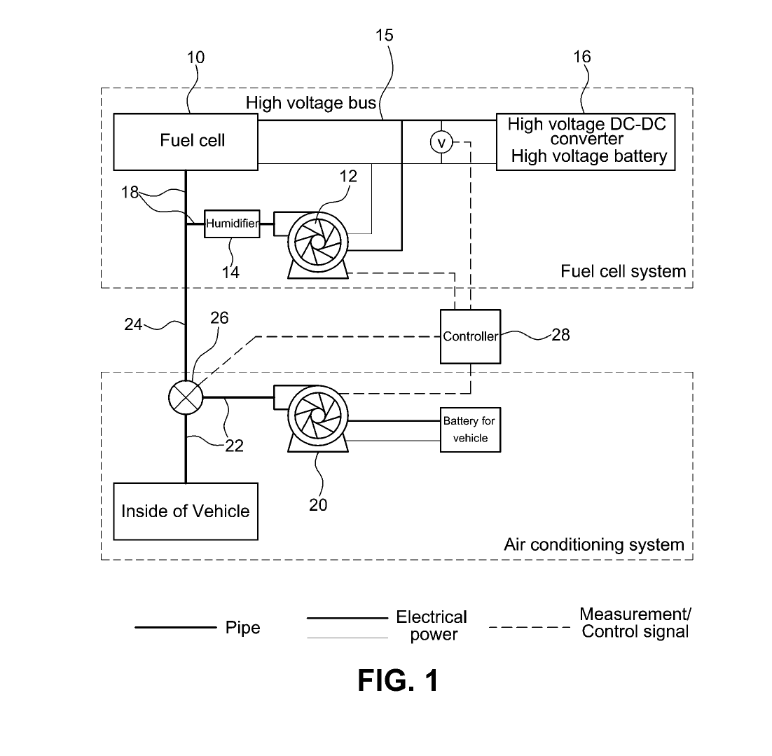

Referring to FIG. 1, an air supply system of a fuel cell includes an air blower 12 for supplying air to an air electrode of a fuel cell 10, a humidifier 14 for humidifying the air supplied from the air blower 12 to the fuel cell 10, and a high voltage system 16 that is a power source of the air blower and includes a high voltage DC-DC converter and a high voltage battery.

In order to solve the problem that start-up of the fuel cell depends on the high voltage DC-DC converter and the high voltage battery, and therefore it is impossible to start the fuel cell in a case of a failure or malfunction of the high voltage DC-DC converter and the high voltage battery, the fuel cell may be started in an emergency by using an air conditioning blower 20 of an air conditioning system equipped within a fuel cell vehicle, upon a failure or malfunction of the high voltage system 16 used as a power source of the air blower 12 during start-up of the fuel cell.

To this end, an outlet pipe 22 of the air conditioning blower 20 and an air electrode inlet pipe 18 of the fuel cell are connected through an air supply pipe 24 for emergency start-up, and a three-way valve 26 is installed at a point where the outlet pipe 22 and the air supply pipe 24 for emergency start-up intersect each other.

The three-way valve 26 serves as a variable valve that guides air, supplied by an operation of the air conditioning blower 20, to an inlet of the air electrode of the fuel cell stack 10 through the air supply pipe 24 for emergency start-up, or to an inside of the vehicle through the outlet pipe 22.

Further, a controller 28 for controlling the operation of the air conditioning blower 20 and a change of an air flow path of the three-way valve 26 is connected to the air conditioning blower 20 and the three-way valve 26.

The controller 28 performs an emergency start-up sequence control when a monitored voltage of a high voltage bus 15 connected between the fuel cell 10 and the high voltage system 16 is lower than or equal to a predetermined voltage value, or upon an error or fault of the high voltage DC-DC converter and the high voltage battery.

During the emergency start-up sequence, the controller 28 controls the change of the air flow path of the three-way valve 26 such that air flows toward the inlet of the air electrode of the fuel cell 10, and at the same time, controls the air conditioning blower 20 such that the air conditioning blower 20 is turned on, so that air supplied by an operation of the air conditioning blower 20 flows to the inlet of the air electrode of the fuel cell 10 through the air supply pipe 24 for emergency start-up.

Accordingly, air is readily supplied to the air electrode of the fuel cell 10 and reacts with hydrogen, supplied from a hydrogen supply system (not shown) to a fuel electrode of the fuel cell 10, for generation of electricity, and the generated electricity flows to the high voltage bus 15 connected between the fuel cell 10 and the high voltage system 16, so that the voltage of the high voltage bus 15 is increased.

When the voltage in the high voltage bus 15 is increased to a reference value (V₁) or higher, the controller 28 determines that the fuel cell is capable of generating electricity. Thereafter, the controller 28 controls the change of the air flow path of the three-way valve such that air flows toward the inside of the vehicle, and controls the air blower 12 to turn on, and at the same time, the air conditioning blower 20 to turn off.

At this time, the air blower 12 may be supplied with the voltage of the reference value or higher in the high voltage bus 15, thereby readily being operated.

Accordingly, air is normally supplied from the air blower 12 to the air electrode of the fuel cell through a normal operation of the air blower 12 so that the fuel cell 10 is normally operated, which enables the vehicle to be operated in a single mode of the fuel cell.

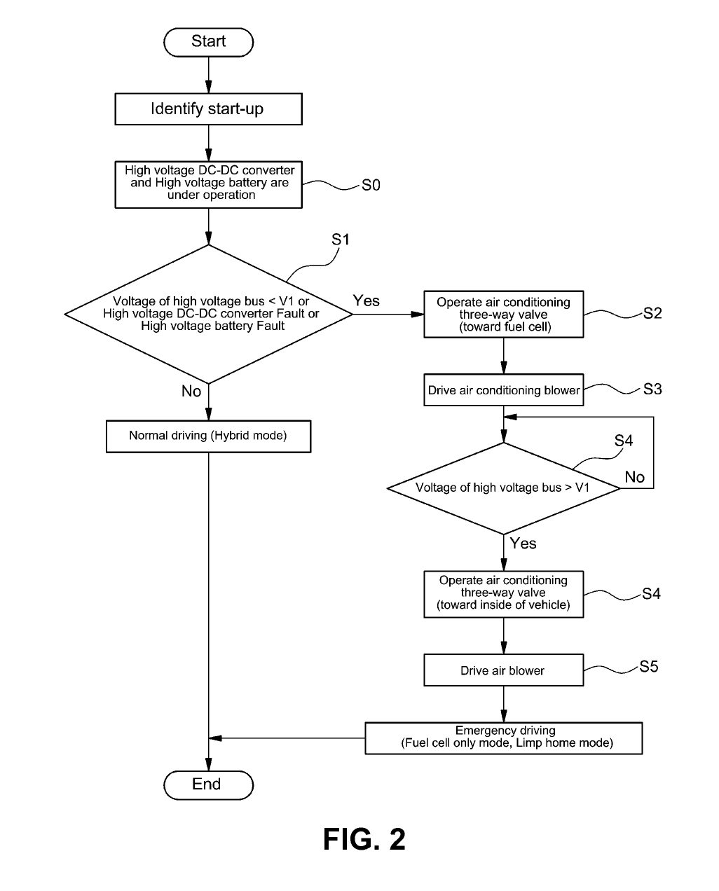

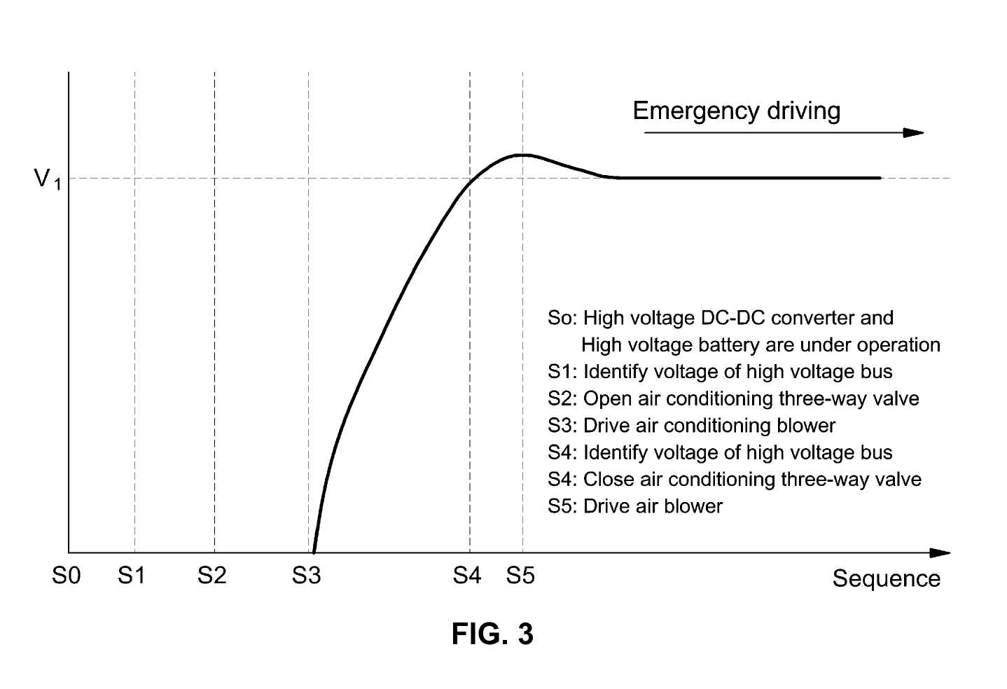

Hereinafter, a method of starting a fuel cell in an emergency according to an embodiment of the present invention, based on the above-described configuration, will be described more specifically with reference to FIGS. 2 and 3.

First, when identifying that a vehicle has been started, the controller 28 operates a high voltage system 16 including a high voltage DC-DC converter and a high voltage battery, in step S0.

Next, the controller 28 monitors a voltage in a high voltage bus 15, in step S1. At this time, the controller 28 performs an emergency start-up sequence control when the monitored voltage of a high voltage bus 15 is lower than or equal to a predetermined voltage value, or upon an error or fault of the high voltage DC-DC converter and the high voltage battery.

To this end, the controller 28 controls a change of an air flow path of a three-way valve 26 such that air flows toward an inlet of an air electrode of a fuel cell 10, in step S2, and at the same time, controls an air conditioning blower 20 such that the air conditioning blower 20 is turned on, in step S3.

Thus, air supplied by operation of the air conditioning blower 20 readily flows to the air electrode of the fuel cell 10 through an air supply pipe 24 for emergency start-up and reacts with hydrogen, supplied to a fuel electrode of the fuel cell 10, for generation of electricity, and the generated electricity flows to the high voltage bus 15 connected between the fuel cell 10 and the high voltage system 16, so that the voltage of the high voltage bus 15 is increased.

Thereafter, when monitoring, in step S4, that the voltage in the high voltage bus 15 has been increased to a reference value (V₁) or higher, the controller 28 determines that the fuel cell is capable of generating electricity.

Accordingly, the controller 28 controls the change of the air flow path of the three-way valve 26 such that air does not flow toward the air electrode of the fuel cell and flows toward the inside of the vehicle, in step S4, and at the same time, controls the air blower 12 to turn on and the air conditioning blower 20 to turn off, in step S5.

At this time, the air blower 12 may be supplied with the voltage of the reference value or higher on the high voltage bus 15 to be readily and normally operated, and thus the air from the air blower 12 may be normally supplied to the air electrode of the fuel cell by the normal operation of the air blower 12.

As described above, despite a failure of the high voltage system, the fuel cell 10 is normally driven as soon as being started in an emergency, which enables the vehicle to be operated in a single mode of the fuel cell, and to be driven to a garage in a limp home mode in the emergency.

Although the invention has been described in detail with reference to preferred embodiment thereof, it will be appreciated by those skilled in the art that the embodiment may be modified without departing from the principle and spirit of the invention, the scope of which is defined in the appended claims and their equivalents.

What is claimed is:

1. An apparatus for starting a fuel cell in an emergency, comprising:
a high voltage system connected with the fuel cell through a high voltage bus;
an air blower operated by electrical power supplied from the high voltage system to supply air to an air electrode of the fuel cell;
an air supply pipe for emergency start-up connected between an air electrode inlet pipe of the fuel cell and an outlet pipe of an air conditioning blower connected to an inside of a vehicle;
a three-way valve installed at a point where the outlet pipe and the air supply pipe for emergency start-up intersect each other, that guides air from the air conditioning blower to the inside of the vehicle or an air electrode inlet of the fuel cell; and
a controller that controls a change of an air flow path of the three-way valve such that air flows toward the air electrode inlet of the fuel cell, and controls the air conditioning blower to be turned on, upon an error or fault of the high voltage system.

2. A method of starting a fuel cell in an emergency, comprising:
operating a high voltage system connected with the fuel cell through a high voltage bus, with the fuel cell being started;
determining an abnormality of the high voltage system;
operating an air conditioning blower when an air blower supplying air to an air electrode of the fuel cell is not to be operated upon the abnormality of the high voltage system;
guiding and supplying the air according to the operating of the air conditioning blower to the air electrode of the fuel cell; and
starting the fuel cell in an emergency, by the air supplied from the air conditioning blower to the air electrode of the fuel cell.

3. The method of claim 2, further comprising:
turning off the air conditioning blower and operating the air blower, when a voltage in the high voltage bus is increased to a reference value or higher after the starting of the fuel cell in the emergency.

4. The method of claim 2, wherein the determining of abnormality of the high voltage system comprises:
monitoring a voltage flowing from a controller to the high voltage bus; and
determining that the high voltage system is abnormal, when the voltage in the high voltage bus is a predetermined voltage or lower as a result of the monitoring.

5. The method of claim 4, wherein the high voltage system is determined to be abnormal, even upon an error or fault of a high voltage DC-DC converter or upon an error or fault of a high voltage battery, in which the high voltage system comprises the high voltage DC-DC converter and the high voltage battery.

6. The method of claim 2, wherein the guiding and supplying of the air according to the operating of the air conditioning blower comprises:
controlling a change of an air flow direction for a three-way valve, installed at a point where an outlet pipe of the air conditioning blower and an air supply pipe for emergency start-up intersect each other, in a state in which the air supply pipe for emergency start-up is connected between an air electrode inlet pipe of the fuel cell and the outlet pipe connected to an inside of a vehicle.

7. The method of claim 6, wherein the controlling of the change of the air flow direction for the three-way valve comprises:
changing an air flow path of the three-way valve such that air flows toward an air electrode inlet of the fuel cell, together with operating of the air conditioning blower; and
changing the air flow path of the three-way valve such that air does not flow toward the air electrode of the fuel cell and flows toward the inside of the vehicle, when a voltage in the high voltage bus is increased to a reference value (V₁) or higher.
